(19) United States
(12) Patent Application Publication
(10) Pub. No.: US 2018/0312206 A1
(43) Pub. Date: Nov. 1, 2018

(54) TRAILER ASSIST SYSTEM AND METHOD

(71) Applicant: Johnathan Goodwin, El Dorado, KS (US)

(72) Inventor: Johnathan Goodwin, El Dorado, KS (US)

(21) Appl. No.: 15/965,277

(22) Filed: Apr. 27, 2018

Related U.S. Application Data
(60) Provisional application No. 62/491,105, filed on Apr. 27, 2017.

(51) Int. Cl. B62D 59/04; B60L 7/10; B62D 61/10; B62D 61/12; B62D 63/06; B62D 65/10; B60L 11/18; H02J 7/14

(52) U.S. Cl. CPC B62D 59/04; B60L 7/10; B62D 61/10; B62D 61/12; B62D 53/00; B62D 65/10; B60L 11/1842; H02J 7/1423; B62D 63/068

(57) ABSTRACT

A system for and method of utilizing and generating electrical power is provided. The trailer assist system is configured to engage with a trailer of a tractor trailer or other vehicle, thereby converting the vehicle into a hybrid vehicle and/or a power generation vehicle as the vehicle travels along a road. The trailer assist system includes one or more drive wheel for selective engagement with the road, an electrical motor being selectively configured to provide power to the drive wheel and a regenerative braking system being selectively configured to generate power from the drive wheel. Retractable positioning wheels are selectively deployed to assist in moving the trailer assist into and out of position relative to a trailer, thereby facilitating exchanging one trailer assist system for another trailer assist system. A control system utilizes information from one or more sensor to optimize performance of the trailer assist system.

### CROSS-REFERENCE TO RELATED APPLICATIONS

This application claims priority pursuant to 35 U.S.C. 119(e) to co-pending U.S. Provisional Patent Application Ser. No. 62/491,105, filed Apr. 27, 2017, the entire disclosure of which is incorporated herein by reference.

### FIELD OF THE INVENTION

The present invention relates generally to clean energy. More specifically, the present invention is concerned with a system for and method of generating, storing, transporting, and utilizing electrical energy, thereby reducing emissions.

### BACKGROUND OF THE INVENTION

Millions of tractor trailers and other vehicles travel billions of miles each year carrying goods and people all across the United States. Consequently, even a small increase in fuel efficiency for such vehicles could make a noticeable difference in overall pollution in the United States.

U.S. Patent Publication Number 2013/0184916 (the “'916 Publication”), the entire disclosure of which is incorporated herein by reference, teaches an apparatus and method for increasing fuel efficiency of an internal combustion engine by including an electric motor and storage batteries to create a hybrid assist vehicle. While the '916 Publication teaches an apparatus and method that was superior to other apparatuses and methods available at that time, the apparatus and methods required a direct mechanical connection between the combustion engine and the assisting motor. Unfortunately, costs associated with retrofitting existing vehicles using such apparatus and methods is often cost prohibitive. Consequently, it would be beneficial to have a system for and method of utilizing electrical energy to help drive vehicles, thereby essentially converting the vehicle into a hybrid vehicle (if the vehicle is not already a hybrid vehicle) or otherwise increasing fuel efficiency of the vehicle.

In addition to the increased use of hybrid technologies in vehicles, the United States has greatly increased its use of alternative energy sources, such as by creating large wind and solar farms. Such farms are often located in remote areas and produce energy at varying rates, many producing excess electrical energy for their respective electrical grids at certain times while producing insufficient amounts of electrical energy for their respective electrical grids at other times. Consequently, it would be beneficial to have a system for storing excess electrical energy. Furthermore, some means of generating power are more efficient and/or more environmentally friendly (“favored power production facilities”) than other means of generating power (“disfavored power production facilities”). Unfortunately, infrastructure costs and other considerations often makes it infeasible or impossible to connect favored power production facilities to certain power grids. Consequently, it would be beneficial to have an economical and environmentally friendly means of transporting stored energy from a first power grid having excess power supplied from a preferred power production facility to a second power grid having less favorable and/or otherwise insufficient power production capabilities.

### SUMMARY OF THE INVENTION

The present invention comprises a trailer assist system for providing additional power to a trailer and a method of generating, utilizing, transporting, and storing energy. The trailer assist system includes a main body for selectively coupling to a trailer of a tractor trailer. In some embodiments, the trailer assist system is configured to fit below a trailer of the tractor trailer and includes one or more drive wheel for selective engagement with the road as the trailer is being pulled behind a semi-tractor. In this way, the one or more drive wheel is able to generate friction between the road and a tire of a drive wheel, thereby enabling the trailer assist system to serve as an additional power source and/or an additional braking means for the tractor trailer.

The trailer assist system includes one or more battery or other means of storing electrical energy (the “batteries”). In some embodiments, the batteries are positioned, at least partially, within an interior area of the main body of the trailer assist system. In other embodiments, the trailer assist system is in electrical communication with one or more batteries displaced from the trailer assist system. In still other embodiments, the one or more other battery, such as a backup battery for a semi-tractor, can be positioned within the interior area of the main body of the trailer for storage of the battery, for charging the battery, and/or as an additional power source for the trailer assist system, the trailer, and/or the semi-tractor.

The batteries are in electrical communication with an electrical motor of the trailer assist system, thereby allowing the trailer assist system to convert potential electrical energy into mechanical energy. The electrical motor is in mechanical communication with one or more drive wheel of the trailer assist system, enabling the trailer assist system to transfer the mechanical energy into kinetic energy for a tractor trailer, thereby increasing the overall efficiency of the tractor trailer.

In some embodiments, the trailer assist system includes a control system that is configured to determine when a trailer is exerting a drag force on a semi-tractor, such as during prolonged uphill driving, thereby enabling the control system to decrease the drag force by causing a driving force to be generated by the drive wheel of the trailer assist system. In some embodiments, the control system is configured to adjust an amount of pushing force exerted on a tractor trailer from a trailer by changing the rotational speed of the drive wheel, thereby enabling the trailer assist system to serve as an alternate drive system, such as during prolonged stretches of predominantly level driving. In this way, strain on engine and drive train components of the semi-tractor can be reduced, thereby increasing the mechanical life of the engine and drive train of the semi-tractor.

In some embodiments, the trailer assist system includes a regenerative braking system in electrical communication with the batteries. In some such embodiments, the regenerative braking system is in mechanical communication with one or more drive wheel, thereby providing additional stopping capabilities for the tractor trailer and/or decreasing strain on the engine and braking systems of the tractor trailer, such as during prolonged stretches of predominantly downhill driving. In this way, the trailer assist system is capable of generating potential electrical energy and storing it for future use.

In some embodiments, a control system of the trailer assist system is configured to control the regenerative braking system of the trailer system. In some such embodiments, the control system is configured to determine when a trailer is exerting a forward force on a semi-tractor, such as during prolonged downhill driving. In some such embodiments, the control system is configured to decrease the forward force exerted on the semi-tractor by increasing a resistive force associated with one or more drive wheel of the trailer assist system.

In addition to the above, the present invention includes methods of attaching, detaching, exchanging, and transporting trailer assist systems and/or other similar systems of the present invention, thereby providing a means of generating, utilizing, and transporting electrical energy.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1A is a schematic view of an embodiment of a trailer assist system of the present invention, the embodiment having a single center drive wheel.

FIG. 1B is a side view of a system depicted by the schematic of FIG. 1A, the system shown with a positioning wheel in a deployed configuration.

FIG. 1C is a side view of a trailer that is configured to selectively couple with the system of FIG. 1B.

FIG. 1D is a side view of the system of FIG. 1B coupled to the trailer of FIG. 1C, the trailer being coupled to a semi-tractor.

FIG. 2A is a schematic view of an embodiment of a trailer assist system of the present invention, the embodiment having two drive wheels.

FIG. 2B is a side view of a system depicted by the schematic of FIG. 2A, the system shown with a positioning wheel in a deployed configuration.

FIG. 2C is a side view of a trailer that is configured to selectively couple with the system of FIG. 2B.

FIG. 2D is a side view of the system of FIG. 2B coupled to the trailer of FIG. 2C, the trailer being coupled to a semi-tractor.

FIG. 3A is a schematic view of an embodiment of a trailer assist system of the present invention, the embodiment having two drive wheels.

FIG. 3B is a side view of a system depicted by the schematic of FIG. 3A, the system shown with a positioning wheel in a deployed configuration.

FIG. 3C is a side view of a trailer that is configured to selectively couple with the system of FIG. 3B.

FIG. 3D is a side view of the system of FIG. 3B coupled to the trailer of FIG. 3C, the trailer being coupled to a semi-tractor.

FIG. 4A is a schematic view of an embodiment of a trailer assist system of the present invention, the embodiment having a single center drive wheel.

FIG. 4B is a side view of a system depicted by the schematic of FIG. 4A, the system shown with a positioning wheel in a deployed configuration.

FIG. 4C is a side view of a trailer that is configured to selectively couple with the system of FIG. 4B.

FIG. 4D is a side view of the system of FIG. 4B coupled to the trailer of FIG. 4C, the trailer being coupled to a semi-tractor.

FIG. 5 is a flow chart showing operations associated with detection of a drag load.

FIG. 6 is a flow chart showing operations associated with detection of a push load.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

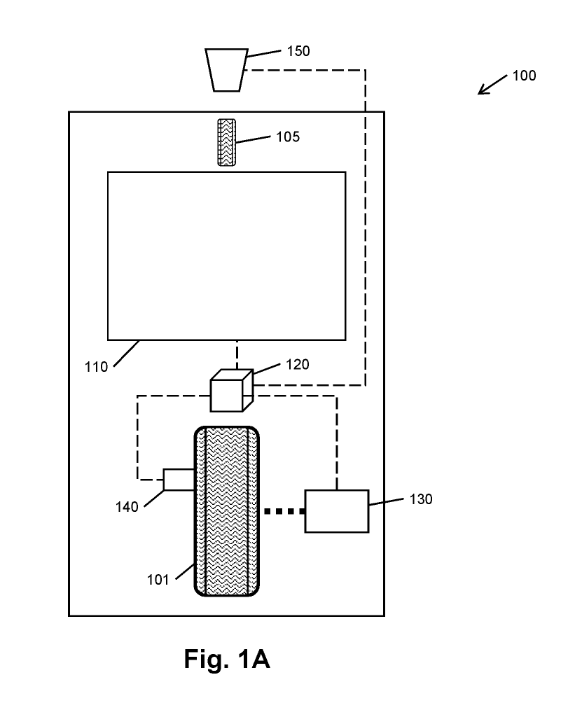

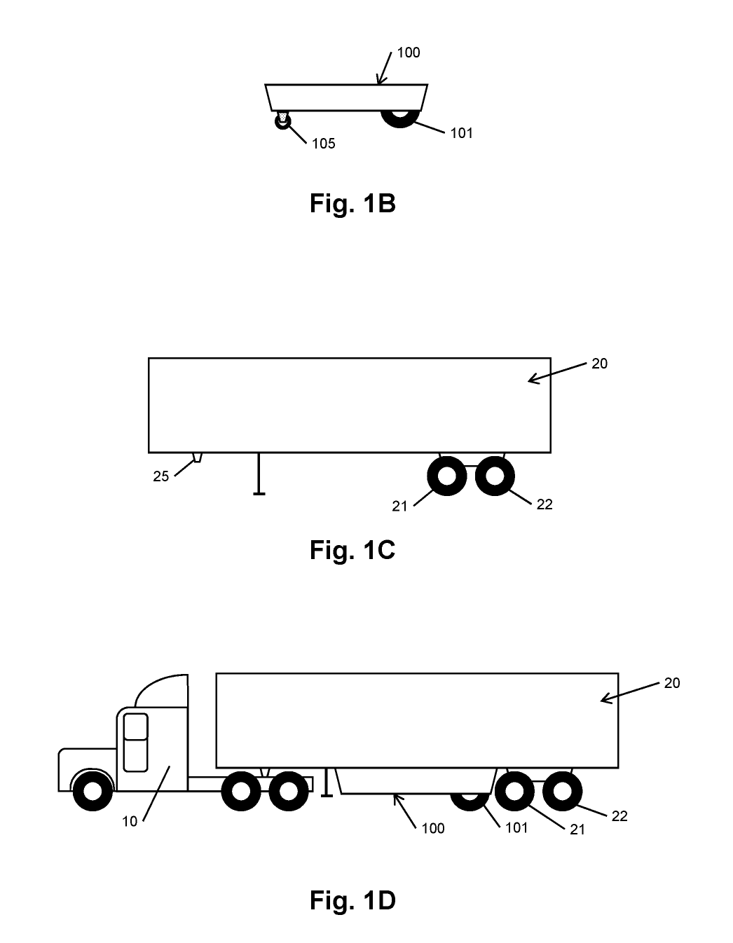

Referring to FIGS. 1A-1D, some embodiments of the present invention comprise a trailer assist system 100 for providing additional power to a trailer and a method of generating, utilizing, transporting, and storing energy. In some embodiments, the trailer assist system 100 is configured to selectively couple to a trailer 20 of a tractor trailer and/or to any other trailer or other device associated with transporting people and/or goods (each herein being a “trailer”). In some embodiments, the trailer assist system 100 is configured to fit below a trailer 20 of the tractor trailer and includes a first drive wheel 101 for selective engagement with the road. In this way, the first drive wheel 101 is able to generate friction between the road and a tire of the first drive wheel 101, thereby enabling the trailer assist system to serve as an additional power source and/or an additional braking means for the trailer.

The trailer assist system 100 includes a power storage bank 110, such as a one or more battery, capacitor, and/or one or more other power storage device now known or later developed. In some embodiments, the power storage bank 110 is positioned, at least partially, within an interior area of a main body of the trailer assist system 100. In some embodiments, the trailer assist system is in electrical communication with one or more power storage bank and/or other power storage device that is displaced from the trailer assist system, such as a car battery or the like. In some embodiments, the trailer assist system 100 includes a plurality of electrical storage banks 110 and/or is configured to be in electrical communication with a plurality of power storage banks 110, such as power storage banks of other trailer assist systems. In some embodiments, the trailer assist system 100 is configured to hold one or more additional power storage device, such as a backup battery for a semi-tractor. In some embodiments, the one or more additional power storage device can be positioned within the interior area of the main body of the trailer for storage of the power storage device, for charging the power storage device, and/or as an additional power source for the trailer assist system, the trailer, and/or one or more other system, such as a semi-tractor.

In some embodiments, the trailer assist system 100 includes a control system 120 in electrical communication with the power storage bank 110, thereby facilitating power flow into the power storage bank 110 (such as from one or more power generating device) and/or facilitating power flow out of the power storage bank 110 (such as to one or more power usage device). In some embodiments, the control system 120 is in electrical communication with a plurality of power storage banks 110 and/or other power storage devices, thereby facilitating flow into and out of each such power storage bank and/or device. In some embodiments, the control system 120 facilitates power flow between two or more power storage banks 110, between two or more power storage devices, and/or between one or more power storage bank 110 and one or more power storage device.

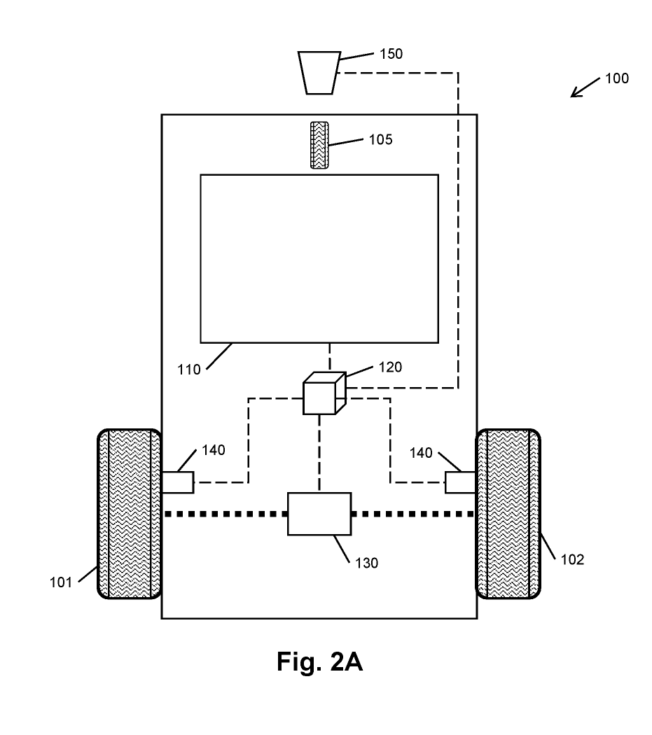

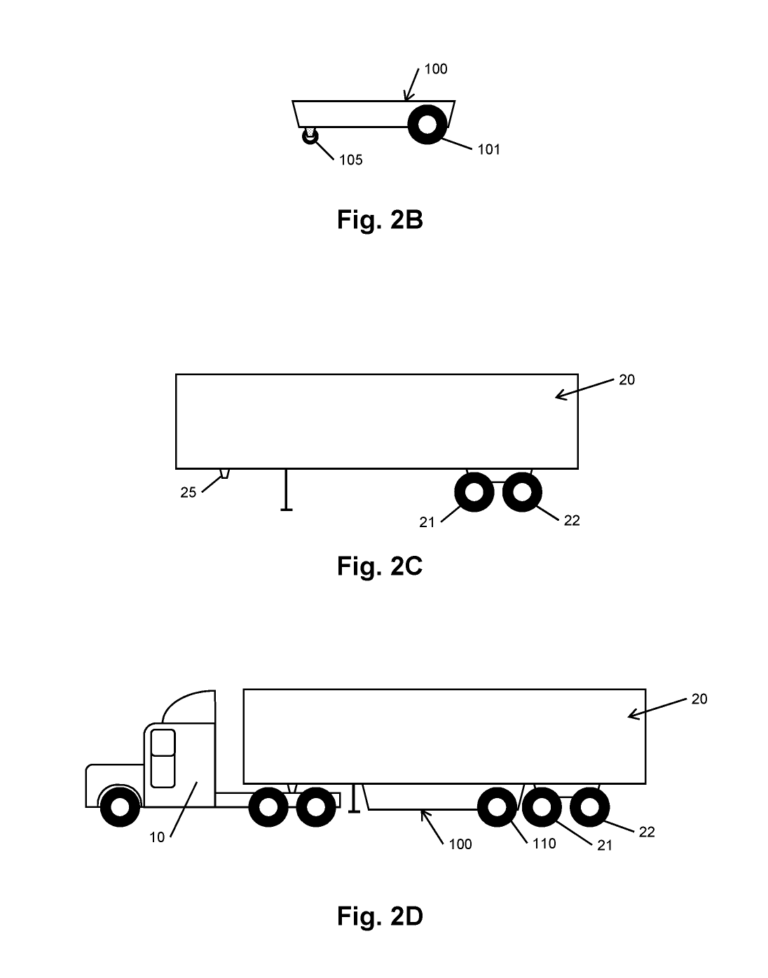

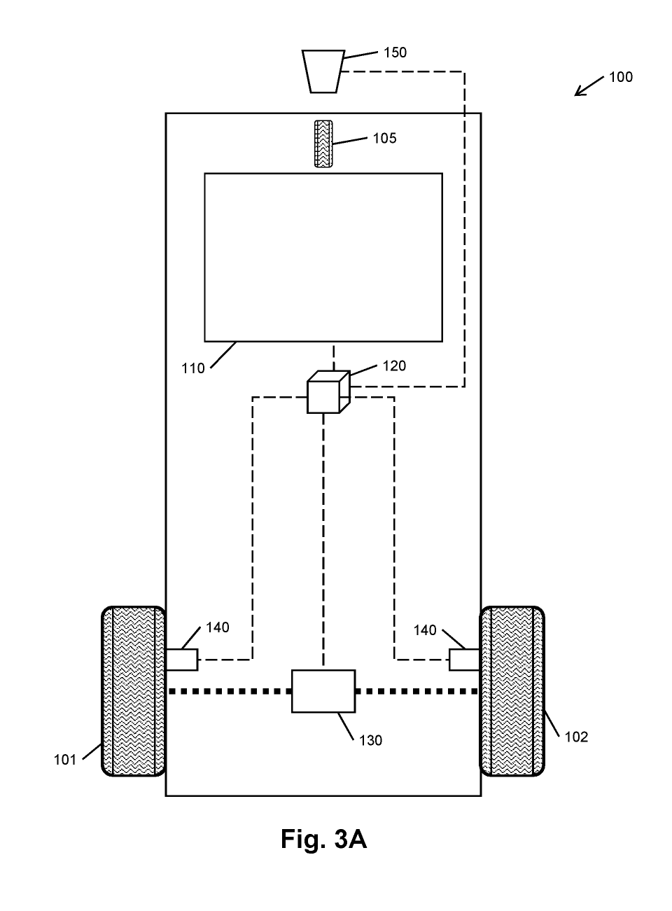

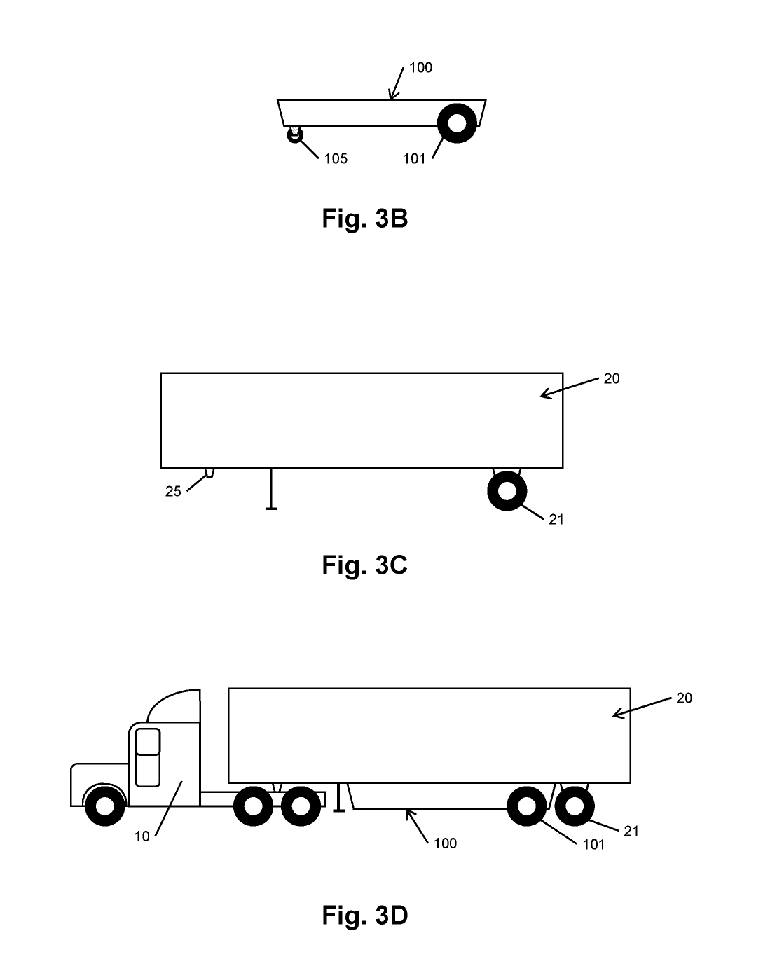

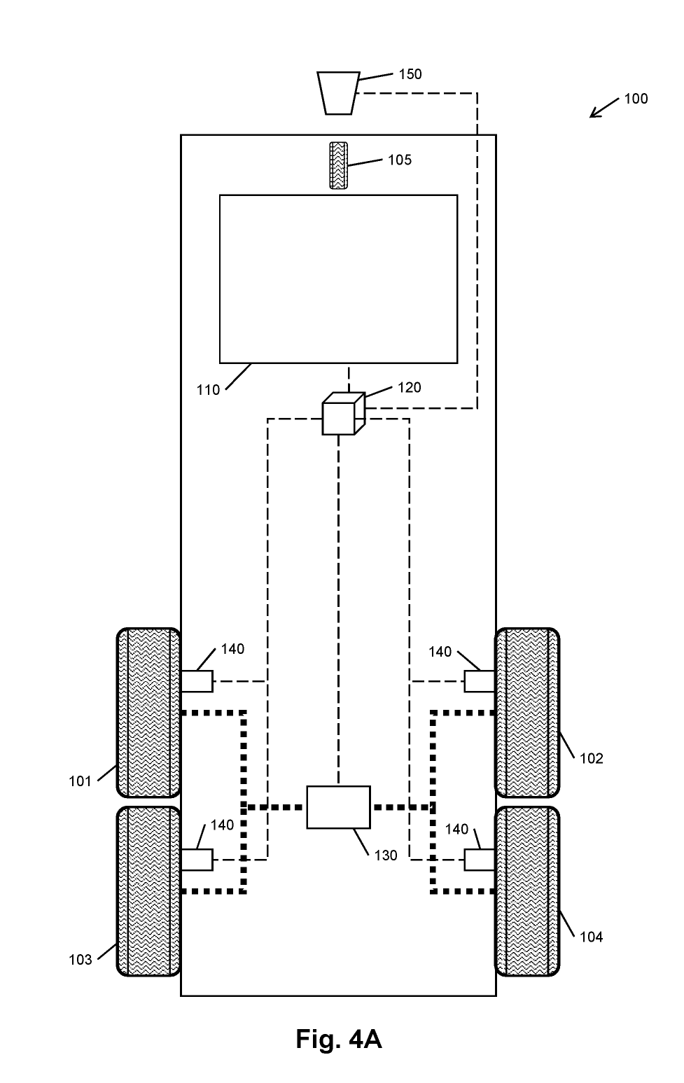

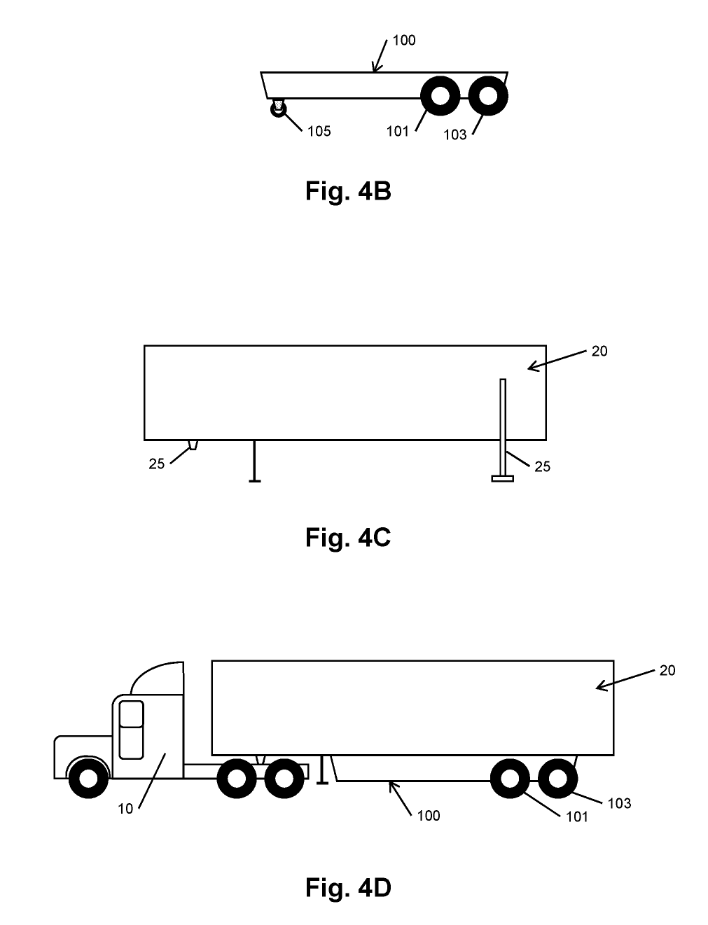

In some embodiments, the trailer assist system 100 includes one or more electrical motor 130 and/or one or more other electrical usage device now known or later developed, such as the electrical motors described in U.S. Pat. No. 8,509,973, the entire disclosure of which is incorporated herein by reference. In some embodiments, the electrical motor 130 is operatively connected to the first drive wheel 101 of the trailer assist system 100. In some embodiments, the electrical motor 130 is operatively connected to a plurality of drive wheels, such as a second drive wheel 102 shown in FIGS. 2A, 3A, and 4A; a third drive wheel 103 shown in FIGS. 4A-4D; and/or a fourth drive wheel 104 shown in FIG. 4A.

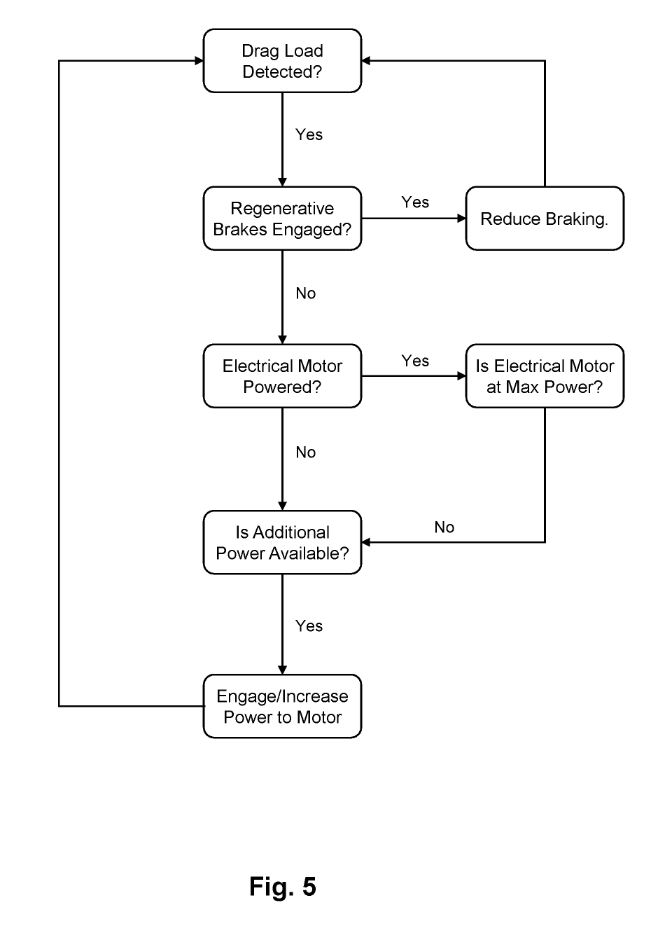

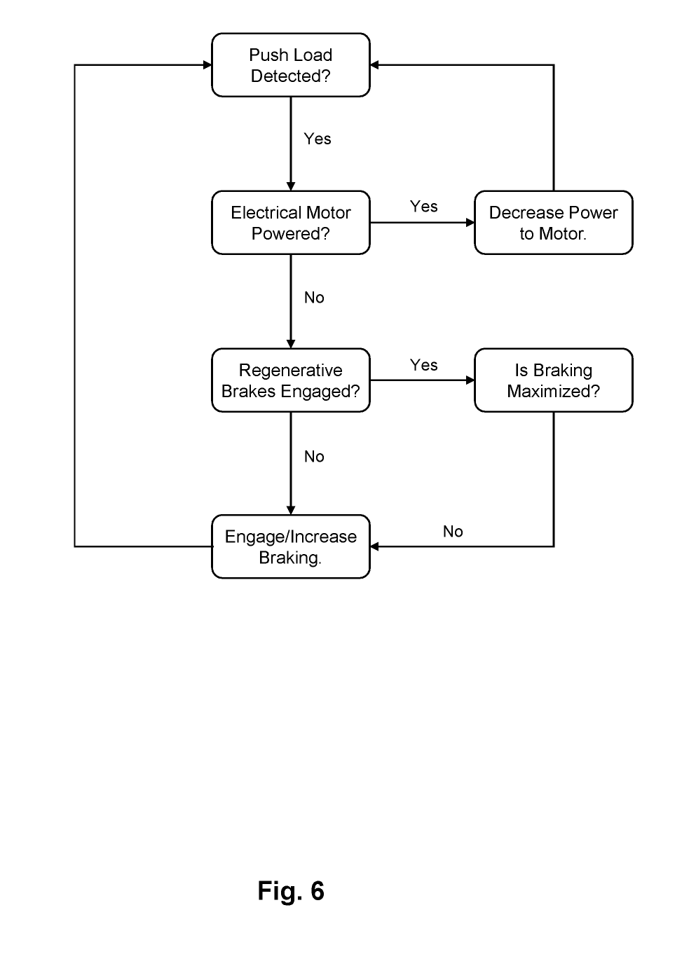

In some embodiments, the control system 120 regulates the rotational speed of the first, second, third, fourth, and/or one or more other drive wheel of the trailer assist system 100. Referring to FIG. 5, some embodiments of the control system 120 of the present invention are configured to detect drag loads, such as drag loads associated with a trailer exerting a drag force on a semi-tractor during prolonged uphill driving. In some embodiments, the control system 120 is configured to detect whether the electrical motor 130 is being powered and at what level the electrical motor 130 is being powered. In some embodiments, determining a level at which an electrical motor 130 is being powered includes determining whether the electrical motor is being powered at a maximum power level, at a minimum power level, and/or at an optimum power level. In some embodiments, the control system is configured to provide such information to a driver and/or user of the trailer assist system 100 and/or to provide similar information to one or more other system and/or person, such as for current use and/or for future review. In this way, use of power and efficiencies associated with such use can be determined and recorded for future reference.

In some embodiments, the control system 120 is configured to control an amount of electrical power directed to the electrical motor 130, such as from the power storage bank 110. In some embodiments, the control system 120 is further configured to control how (and/or whether) the electrical motor is operatively connected to one or more drive wheel of the trailer assist system, thereby controlling how (and/or whether) the electrical motor is able to generate a driving force through such drive wheel(s).

In some embodiments, the trailer assist system 100 includes one or more regenerative braking system 140 and/or one or more other electrical generation device now known or later developed. In some embodiments, the system utilizes a generator and/or a capacitor bank, such as taught by U.S. Patent Publication Number 2009/0250276, the entire disclosure of which is incorporated herein by reference.

In some embodiments, the regenerative braking system is in electrical communication with the power storage bank 110, such as through the control system 120. In some embodiments, a first regenerative braking system 120 is operatively connected to a first drive wheel 101 of the trailer assist system. In some embodiments, the first regenerative braking system 140 is operatively connected to a plurality of drive wheels and/or a plurality of regenerative braking systems 140 are connected to at least one of one or more drive wheel. In some embodiments, the control system 120 regulates the use of and/or engagement of one or more regenerative braking system.

In some embodiments, the control system is configured to detect push loads, such as when a trailer is exerting a forward force on a semi-tractor during prolonged downhill driving. In some embodiments, the control system is configured to decrease the push load by increasing a resistive force associated with one or more drive wheel of the trailer assist system 100, such as by increasing braking associated with one or more regenerative braking system 140. In some embodiments, the control system 120 is configured to decrease power to one or more electrical motor and/or decouple such motor(s) from one or more drive wheel of the present invention when a push load is detected.

In some embodiments, the control system 120 is configured to eliminate or otherwise minimize impulses, such as lurching or other impulsive driving conditions associated with pulling a trailer behind a semi-tractor or other vehicle. In some embodiments, impulses are reduced and/or eliminated by controlling the rotational speed of one or more drive wheel of the trailer assist system 100. In some such embodiments, the control system 120 is in data communication with a computer system of a tow vehicle (such as a semi-tractor) and/or is otherwise configured to obtain information pertaining to rotational speed of one or more drive wheel of such vehicle, thereby enabling adjustment of the rotational speed of one or more drive wheel of the trailer assist system with respects to an adjustment in rotational speed of one or more wheel of such vehicle.

In some embodiments, the control system 120 is in data communication with one or more sensor 150 associated with the trailer. In some embodiments, the sensor 150 is positioned at an interface between the trailer 20 and a tow vehicle 10, thereby enabling the control system 120 to determine whether the trailer 20 is exerting a push load or a drag load on the tow vehicle 10. In some embodiments, a plurality of sensors 150 are utilized to determine a plurality of other information, such as tongue weight, axle weight, vehicle orientation, vehicle speed, etc., thereby allowing the control system 120 to determine a safe and appropriate action regarding braking and/or driving forces associated with the trailer assist system 100.

The present invention further includes a method of securing a trailer assist system of the present invention to a trailer. In some embodiments, the trailer assist system is moved into position under the trailer prior to being raised into engagement with the trailer. In other embodiments, the trailer is moved into position over the trailer assist system prior to being lowered into engagement with the trailer assist system. It will be appreciated that in various embodiments, the trailer and/or the trailer assist system are moved relative to the other so as to facilitate engagement with each other. In some such embodiments, the trailer and/or the trailer assist system include an adjustable suspension system for selectively raising and lowering the trailer and/or the trailer assist system.

In some embodiments, the trailer assist system 100 includes one or more positioning wheel 105 for moving the trailer assist system along a surface, such as a surface of a parking lot, and into engagement with a trailer 20. In some such embodiments, the one or more positioning wheel 105 is configured to retract into the main body of the trailer assist system and/or is configured to otherwise move away from the surface when the trailer assist system is engaged with a trailer, thereby ensuring that the one or more positioning wheel is displaced from the road when the trailer is being pulled along the road.

In some embodiments, one or more drive wheel is selectively moveable between a stowed configuration and a deployed configuration when the trailer assist system is coupled to a trailer. In the stowed configuration, a drive wheel is displaced from the road. In the deployed configuration, a drive wheel is configured to selectively engage with the road. In some embodiments, an outer circumference of one or more drive wheel is equivalent in size to an outer circumference of a primary wheel of the trailer. In other embodiments, the outer circumference is measurably smaller or larger than an outer circumference of a primary wheel of the trailer.

In some embodiments, one or more primary wheel of a trailer 20 serves as a drive wheel of the trailer assist system 100. In other embodiments, the trailer assist system serves as a wheel carriage for an aft end of a trailer. In some such embodiments, the present invention includes a method of converting a traditional trailer into a trailer assist system enabled trailer by removing a first axle 21, a second axle 22, and/or one or more other traditional axle from the trailer 20 and coupling one or more trailer assist system 10 to the trailer. In some embodiments, the trailer assist system is configured to couple directly to a vehicle, such as a tractor truck.

The present invention further includes a method of removing an old trailer assist system from a trailer and/or a vehicle, thereby enabling a new trailer assist system to be installed thereto. In some embodiments, the method includes disengaging the old trailer assist system from the trailer and moving the trailer assist system and trailer away from each other. In some embodiments, the method includes moving one or more positioning wheel of the old trailer assist system into engagement with the ground and/or lowering the trailer prior to disengaging the old trailer assist system from the trailer. In some embodiments, the method further includes lowering the old trailer assist system and/or raising the trailer prior to moving the old trailer assist system and the trailer away from each other.

The present invention further includes a method of utilizing a plurality of trailer assist systems to decrease pollution. In some embodiments, a plurality of trailer assist systems are provided at a plurality of exchange facilities for selective engagement with trailers of tractor trailers. In some such embodiments, one or more trailer assist system includes batteries having fully charged or substantially charged batteries, thereby possessing a substantial amount of potential energy in the form of stored electrical energy. In some embodiments, at least some of the exchange facilities are located at and/or located in close proximity to truck stops, weigh stations, rest areas, or other facilities frequented by truck drivers. In this way, truck drivers are able to conveniently pick up, drop off, or exchange trailer assist systems with minimal impact to their regular routines.

In some embodiments, at least some exchange facilities are located in relative close proximity to power generation facilities, include their own power generation means, and/or are in electrical communication with one or more power generation facility. In this way, such exchange facilities are capable of utilizing one or more trailer assist system and/or one or more battery from a trailer assist system as a means of capturing and storing electrical power from a power grid during periods of excess power generation and/or providing power to the electrical grid during periods of low power generation.

In some embodiments, at least some exchange facilities are located at or near a base of a mountain range (“mountain base facilities”), thereby allowing truck drivers to acquire fully charged and/or substantially charged trailer assist systems prior to ascending a mountain range and/or to drop off fully charged and/or substantially charged trailer assist systems after descending the mountain range. In this way, truck drivers can choose to utilize stored electrical energy to assist in ascending the mountain range and/or to generate electrical energy upon descending the mountain range regardless of whether the truck driver utilizes the trailer assist system on plains surrounding the mountain range. In some embodiments, mountain base facilities are located at or near “tire chain” stations, thereby enabling a truck driver to add tire chains to other wheels of the tractor trailer while acquiring one or more trailer assist system. In other embodiments, one or more trailer assist system includes one or more feature for assisting tractor trailers while ascending and/or descending mountain ranges, thereby reducing or eliminating a need for tire chains. In still other embodiments, one or more exchange facility is positioned at or near a summit of a mountain range, thereby enabling utilization of power at or near the summit of the mountain range and generation of power as tractor trailers descend from the summit.

The present invention further includes a method of transporting energy. In some embodiments, the method includes utilizing one or more trailer assist system to capture and store excess electrical energy from a first power grid, transporting the trailer assist system to a second power grid, and utilizing the electrical energy stored in the trailer assist system as back-up power and/or supplemental power for the second power grid. In some such embodiments, the method further includes connecting batteries of the one or more trailer assist system to the first power grid so that the batteries are in electrical communication with the first power grid, disconnecting the batteries from the first power grid, and connecting the batteries to the second power grid so that the batteries are in electrical communication with the second power grid. In this way, energy generated or required by a remote power grid can be utilized or provided, respectively, without requiring expensive infrastructure associated with physically connecting the remote power grid to one or more other power grid. In other embodiments, the present invention provides temporary power needs during construction, repair, and/or maintenance infrastructure.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A system for increasing efficiency of a semi-tractor of a tractor trailer as the tractor trailer travels along a road, the system comprising:
a main body for selective mechanical engagement with a trailer of a tractor trailer;
a battery positioned in an interior area of the main body;
an electrical motor in electrical communication with the battery; and
a first drive wheel in mechanical communication with the electrical motor,
wherein a tire of the first drive wheel is configured to engage with the road.

2. The system of claim 1, further comprising a regenerative braking system for generating electrical energy during braking of the tractor trailer.

3. The system of claim 1, wherein the first drive wheel is positioned forward of a dual axle of the trailer, thereby providing a third axle for the trailer.

4. The system of claim 3, wherein the first drive wheel is a center drive wheel positioned laterally at are adjacent to a lateral center of the trailer.

5. The system of claim 3, further comprising a second drive wheel, the first and second drive wheel being positioned laterally at or adjacent to opposed first and second sides of the trailer.

6. The system of claim 1, wherein the first drive wheel is positioned forward of a single axle of the trailer, thereby providing a second axle for the trailer.

7. The system of claim 1, further comprising a second drive wheel, the first and second drive wheels being positioned laterally at or adjacent to opposed first and second sides of the trailer, thereby providing a first axle of the trailer.

8. The system of claim 7, further comprising third and fourth drive wheels positioned aft of the first and second drive wheels, respectively, thereby providing a second axle of the trailer.

9. The system of claim 1, further comprising a positioning wheel moveable between a stowed configuration and a deployed configuration, the positioning wheel being displaced from the road in the stowed configuration and being configured to support a portion of the system in the deployed configuration, wherein moving the positioning wheel from the stowed configuration to the deployed configuration facilitates moving the system relative to the trailer, thereby facilitating installing the system to the trailer and removing the system from the trailer, and wherein moving the positioning wheel from the deployed configuration to the stowed configuration facilitates the semi-tractor pulling the trailer along the road.

10. The system of claim 1 wherein the first drive wheel is moveable between a stowed configuration and a deployed configuration, thereby moving the tire of the first drive wheel into and out of engagement with the road.

11. A method of installing a trailer assist system to a trailer of a tractor trailer, the method comprising:
moving at least one of the trailer and the trailer assist system until the trailer assist system is positioned under the trailer; and
securing the trailer assist system to the trailer.

12. The method of claim 11, further comprising lifting the trailer to provide additional clearance under the trailer.

13. The method of claim 12, further comprising lowering the trailer towards the trailer assist system so as to facilitate securing the trailer assist system to the trailer.

14. The method of claim 11, further comprising lowering the trailer assist system prior to moving the trailer assist system into position relative to the trailer.

15. The method of claim 14, further comprising lifting the trailer assist system towards the trailer after the trailer assist system is moved into position relative to the trailer.

16. The method of claim 11, further comprising supporting a rear end of the trailer while moving the trailer assist system into position relative to the trailer.

17. The method of claim 16, wherein the means of supporting the rear end of the trailer such that the trailer assist system is capable of moving forward from a first position behind the trailer to a second position under the trailer.

18. A method of transporting energy comprising:
storing electrical energy in a plurality of batteries, the plurality of batteries being in electrical communication with a first power grid;
disconnecting the plurality of batteries from the first power grid so that the plurality of batteries are no longer in electrical communication with the first power grid;
transporting the plurality of batteries under a trailer of a tractor trailer;
connecting the batteries to a second power grid so that the plurality of batteries are in electrical communication with the second power grid.

19. The method of claim 18, further comprising utilizing at least some of the electrical energy stored in the batteries as a fuel source for powering the tractor trailer as it travels from the first power grid to the second power grid.

20. The method of claim 19, further comprising utilizing a regenerative braking system to generate electrical power as the tractor trailer travels from the first power grid to the second power grid and storing at least some of the generated electrical power in at least one of the plurality of batteries.
